(19) United States
(12) Patent Application Publication
(10) Pub. No.: US 2021/0190266 A1
(43) Pub. Date: Jun. 24, 2021

(54) METHOD OF MANUFACTURING HIGH-PRESSURE TANK

(71) Applicant: TOYOTA JIDOSHA KABUSHIKI KAISHA, Toyota-shi (JP)

(72) Inventors: Masayoshi TAKAMI, Hamamatsu-shi (JP); Takashi INOH, Okazaki-shi (JP)

(73) Assignee: TOYOTA JIDOSHA KABUSHIKI KAISHA, Toyota-shi (JP)

(21) Appl. No.: 17/195,862

(22) Filed: Mar. 9, 2021

Related U.S. Application Data
(62) Division of application No. 15/908,680, filed on Feb. 28, 2018.

(30) Foreign Application Priority Data
Mar. 3, 2017 (JP) 2017-040168

(51) Int. Cl. F17C 1/16

(52) U.S. Cl. CPC F17C 1/16; F17C 2270/0184; F17C 2203/0663; F17C 2203/066; F17C 2223/0123; F17C 2205/0305; F17C 2205/0397; F17C 2209/2154; F17C 2201/056; F17C 2270/0189; F17C 2223/036; F17C 2201/0109; F17C 2203/011; F17C 2203/0604; F17C 2203/0621; F17C 2203/0673; F17C 2221/012; F17C 2201/058

(57) ABSTRACT

A high-pressure tank includes: a liner; an epoxy resin; a fiber; and a fiber-reinforced epoxy resin layer formed on an outer side of the liner. The epoxy resin has a contact angle on polytetrafluoroethylene ((C₂F₄)ₙ) of 70° or less in an uncured state.

### CROSS REFERENCE TO RELATED APPLICATIONS

The present application claims the priority based on Japanese Patent Application No. 2017-040168 filed on Mar. 3, 2017, the disclosure of which is hereby incorporated by reference in its entirety.

### BACKGROUND

### Field

The technique disclosed herein relates to a high-pressure tank.

### Related Art

A known high-pressure tank filled with a fluid such as hydrogen gas under high pressure includes a liner having a gas barrier property and a carbon fiber-reinforced resin layer (outer shell) formed on a surface of the liner (for example, refer to JP-A-1996-285189).

In such a high-pressure tank, cracking can occur in the outer shell due to, for example, a change in the volume in the high-pressure tank as a result of repeated filling and release of the fluid. A technique for suppressing occurrence of cracking in the outer shell of the high-pressure tank is hereinafter disclosed.

The technique disclosed herein has been developed in order to address at least part of the aforementioned problem, and can be achieved in the following aspects.

### SUMMARY

In an aspect of the technique disclosed herein, there is provided a high-pressure tank. The high-pressure tank comprises: a liner; and a fiber-reinforced epoxy resin layer formed on an outer side of the liner. The fiber-reinforced epoxy resin layer may include an epoxy resin and fibers. The epoxy resin has a contact angle on polytetrafluoroethylene ((C₂F₄)ₙ) of 70° or less in an uncured state.

### BRIEF DESCRIPTION OF DRAWINGS

FIG. 1 is a cross-sectional view illustrating a schematic configuration of a high-pressure tank according to one embodiment of the technique of the present disclosure.

FIG. 2 is a diagram illustrating components of epoxy resin included in a reinforcement layer.

FIG. 3 is a flowchart illustrating a method for manufacturing the high-pressure tank.

FIG. 4 is a diagram schematically illustrating the configuration of a reinforcement layer according to a second embodiment.

FIG. 5 is a diagram illustrating relationship between the contact angle of the epoxy resin and the durability of the high-pressure tank.

### DETAILED DESCRIPTION

### A1. First Embodiment

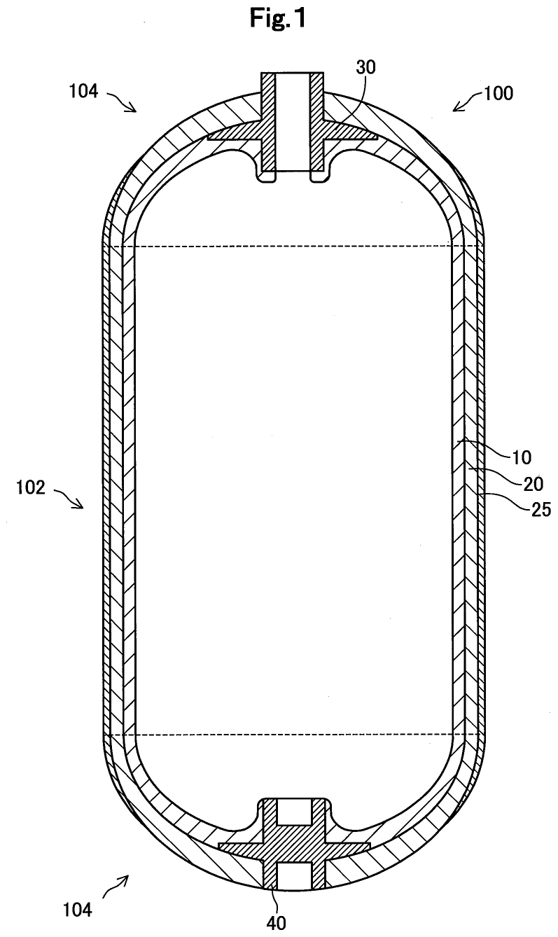

FIG. 1 is a cross-sectional view illustrating a schematic configuration of a high-pressure tank 100 according to one embodiment of the technique of the present disclosure. FIG. 1 is a cross-sectional view taken along a line passing through the center axis of the high-pressure tank 100. For example, the high-pressure tank 100 according to the present embodiment is filled with compressed hydrogen. For example, the high-pressure tank 100 is installed in a fuel cell vehicle and supplies hydrogen to a fuel cell. The high-pressure tank 100 may be installed in a vehicle other than fuel cell vehicles, such as an electric vehicle or a hybrid vehicle, and may be installed in other moving bodies such as a vessel, an aircraft, and a robot. The high-pressure tank 100 may be stationary equipment installed in a residence, a building, or the like.

The high-pressure tank 100 is a hollow container including: a cylindrical portion 102 having a substantially cylindrical shape; and dome portions 104 that have a semispherical shape, provided to both ends of the cylindrical portion 102, and are integrally formed with the cylindrical portion 102. In FIG. 1, the boundaries between the cylindrical portion 102 and the dome portions 104 are illustrated in broken lines. The high-pressure tank 100 has the center axis matching that of the cylindrical portion 102.

The high-pressure tank 100 includes a liner 10, a reinforcement layer 20, a protection layer 25, a mouthpiece 30, and a mouthpiece 40. The liner 10 to which the mouthpiece 30 and the mouthpiece 40 are attached is hereinafter also referred to as “tank main body”.

The liner 10 is made of nylon resin, and has a property (what is known as a gas barrier property) for sealing hydrogen or the like, filled in an internal space, so that the hydrogen or the like does not leak out. The liner 10 may also be made of another synthetic resin having the gas barrier property such as polyethylene-based resin, or may be made of metal such as aluminum or stainless steel.

The reinforcement layer 20 is formed to cover the outer surface of the tank main body. Specifically, the reinforcement layer 20 is formed to entirely cover the outer surface of the liner 10 and partially cover the mouthpieces 30 and 40. The reinforcement layer 20 is made of Carbon Fiber-Reinforced Plastics (CFRP), which is a composite material of epoxy resin and carbon fibers, and has pressure resistance. A physical property of epoxy resin is described later. The reinforcement layer 20 according to the present embodiment is also referred to as “fiber-reinforced epoxy resin layer”.

The protection layer 25 is formed on the reinforcement layer 20. The protection layer 25 is made of Glass Fiber-Reinforced Plastics (GFRP), which is a composite material of thermoset resin and glass fibers, and has higher impact resistance than the reinforcement layer 20. In the present embodiment, the impact resistance is evaluated with the Charpy impact test (ISO 179-1). In the present embodiment, the epoxy resin that is same as that in the reinforcement layer 20 is used as the thermoset resin. The thermoset resin included in the protection layer 25 may be epoxy resin with a physical property different from that of the epoxy resin included in the reinforcement layer 20, or may be another thermoset resin such as unsaturated polyester resin. The epoxy resin with a physical property different from that of the epoxy resin included in the reinforcement layer 20 is obtained by adjusting the type or amount of hardening agent and hardening accelerator and the molecular weight of the epoxy resin to be different from those of the epoxy resin included in the reinforcement layer 20. The protection layer 25 according to the present embodiment is also referred to as “fiber-reinforced resin layer”.

The mouthpieces 30 and 40 are each attached to a corresponding one of two opening ends of the liner 10. The mouthpiece 30 functions as an opening of the high-pressure tank 100, and also functions as an attachment portion for attaching a pipe or a valve to the tank main body. The mouthpieces 30 and 40 also function as attachment portions for attaching the tank main body to a filament winding device (hereinafter, referred to as “FW device”), when the reinforcement layer 20 and the protection layer 25 are formed.

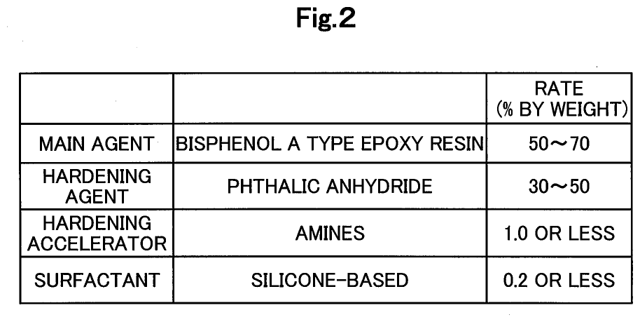

FIG. 2 is a diagram illustrating components of the epoxy resin included in the reinforcement layer 20. The epoxy resin included in the reinforcement layer 20 includes 50 to 70% by weight of bisphenol A type epoxy resin serving as a main agent, 30 to 50% by weight of phthalic anhydride serving as a hardening agent, 1.0% by weight or less of amines serving as a hardening accelerator, and 0.2% by weight or less of a silicone-based surfactant serving as a surfactant. The epoxy resin included in the reinforcement layer 20 has such a composition that the main agent and the hardening agent fall within the range in FIG. 2 and the total of these accounts for 100% by weight.

The epoxy resin included in the reinforcement layer 20 has a contact angle on a polytetrafluoroethylene ((C₂F₄)ₙ) plate of 70° or less in an uncured state. In the following description, the contact angle on polytetrafluoroethylene ((C₂F₄)ₙ) is also simply referred to as “contact angle”. The contact angle is measured by the following method.

### <Method for Measuring Contact Angle>

Measuring device: Kyowa Interface Science Co., Ltd., CA-X150
Polytetrafluoroethylene ((C₂F₄)ₙ) plate: The Nilaco Corporation, Teflon plate, model number 965653 (Teflon is a registered trademark)
Measuring method: Measuring the contact angle at seven points 10 seconds after resin droplets hit on the surface of the Teflon plate, and averaging the five points excluding the maximum and minimum values.

The contact angle is an index of wettability, and a smaller contact angle indicates better wettability. Polytetrafluoroethylene ((C₂F₄)ₙ), which has a water-repellent surface, enables stable measuring of the contact angle of the epoxy resin. For this reason, the contact angle on polytetrafluoroethylene ((C₂F₄)ₙ) plate is used herein as an index of wettability. The epoxy resin included in the reinforcement layer 20 according to the present embodiment has a contact angle of 70° or less, which indicates good wettability.

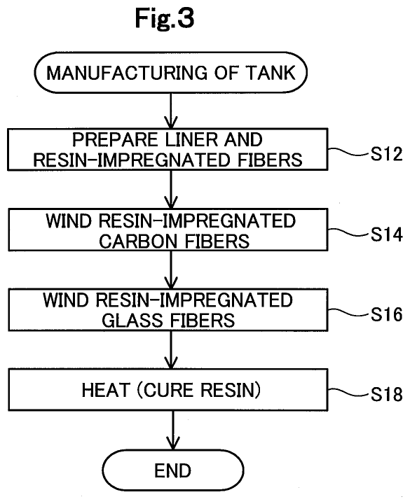

FIG. 3 is a flowchart illustrating a method for manufacturing the high-pressure tank 100. In the present embodiment, the high-pressure tank 100 (FIG. 1) is formed by a filament winding method (FW method). In step S12, the liner 10 and resin-impregnated fibers (resin-impregnated carbon fibers and resin-impregnated glass fibers) are prepared. More specifically, the tank main body including the liner 10 to which the mouthpiece 30 and the mouthpiece 40 are attached is set to a FW device (not illustrated) as a mandrel. The resin-impregnated carbon fibers wound around a bobbin are set to predetermined positions of the FW device. The glass fibers wound around a bobbin are set to predetermined positions of the FW device. In the present embodiment, tow (bundle) carbon fibers and glass fibers are used. In addition, the above-described epoxy resin is used as the resin. As described above, the epoxy resin used in the present embodiment has good wettability in an uncured state and thus sufficiently penetrates between the fibers.

In step S14, resin-impregnated carbon fibers are wound around the outer surface of the tank main body. More specifically, as the FW device starts operating to cause the tank main body to rotate, the resin-impregnated carbon fibers are fed from the bobbin, and the resin-impregnated carbon fibers are wound around the outer surface of the tank main body. In this process, hoop winding, helical winding, and other types of winding are combined as appropriate, whereby the resin-impregnated carbon fibers are wound around the outer surface of the tank main body. Hereinafter, the tank main body with the resin-impregnated carbon fibers wound around its outer surface is also referred to as “carbon fiber-wound tank main body”. After the resin-impregnated carbon fibers are wound for a predetermined number of times to form a resin-impregnated carbon fiber layer, the resin-impregnated carbon fibers are cut and their winding finish end (terminal end) is bonded under pressure (e.g., thermal compression bonding) to a winding start end (start end) of resin-impregnated glass fibers.

In step S16, on the resin-impregnated carbon fiber layer of the carbon fiber-wound tank main body formed in step S14, the resin-impregnated glass fibers are wound in the same manner as in step S14 to form a resin-impregnated glass fiber layer.

In step S18, the fiber-wound tank main body including the liner 10 the outer periphery of which is provided with the resin-impregnated carbon fiber layer and the resin-impregnated glass fiber layer formed through steps S14 and 16 is placed in a furnace. The fiber-wound tank main body is heated, while being rotated, so that the epoxy resin in the resin-impregnated carbon fiber layer and the resin-impregnated glass fiber layer reaches its curing temperature (for example, about 160° C.). For example, the fiber-wound tank main body is heated at a set temperature of 180° C. of the furnace for 50 minutes, and then the fiber-wound tank main body is heated at a set temperature of 160° C. for 20 minutes.

As the epoxy resin is cured in step S18, the reinforcement layer 20 and the protection layer 25 are formed. Subsequently, the set temperature of the furnace is lowered, and the high-pressure tank 100 is taken out therefrom. In this manner, since the high-pressure tank 100 is formed by the FW method, the reinforcement layer 20 and the protection layer 25 each have a plurality of layers corresponding to the number of winding of the resin-impregnated carbon fibers and the resin-impregnated glass fibers. For example, the reinforcement layer 20 may include 30 layers, while the protection layer 25 may include 2 layers.

As described above, in the high-pressure tank 100 according to the present embodiment, the epoxy resin included in the reinforcement layer 20 has a contact angle of 70° or less and good wettability in an uncured state, and thus easily penetrates between tow carbon fibers when the fibers are impregnated with the resin. Therefore, the epoxy resin when cured fills the space between the fibers, whereby formation of voids (minute cavities) in the reinforcement layer 20 is suppressed. As a result, concentration of stress in the reinforcement layer 20 is alleviated, whereby occurrence of cracking in the reinforcement layer 20 because of a change in the volume as a result of the filling and release of hydrogen gas in the high-pressure tank 100 can be suppressed.

### A2. Second Embodiment

A high-pressure tank according to a second embodiment includes a reinforcement layer 20A, instead of the reinforcement layer 20 in the high-pressure tank 100 according to the first embodiment. The high-pressure tank according to the second embodiment have the configuration same as that of the high-pressure tank 100 according to the first embodiment, except for the reinforcement layer 20A, and the same components are denoted with the same reference numerals and their descriptions will be omitted.

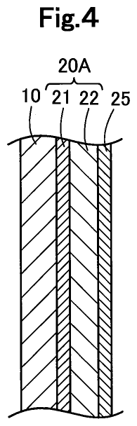

FIG. 4 is a diagram schematically illustrating the configuration of the reinforcement layer 20A according to the second embodiment. FIG. 4 is an enlarged view of a part of the configuration of the high-pressure tank 100 along a cut surface passing through the center axis of the high-pressure tank. The reinforcement layer 20A includes a first reinforcement layer 21 and a second reinforcement layer 22. The first reinforcement layer 21 is formed on the liner 10 (that is, in contact with the liner 10), and the second reinforcement layer 22 is formed on the first reinforcement layer 21 (that is, in contact with the first reinforcement layer 21). The protection layer 25 is formed on the second reinforcement layer 22 (that is, in contact with the second reinforcement layer 22). The epoxy resin included in the first reinforcement layer 21 is the same as the epoxy resin included in the reinforcement layer 20 according to the first embodiment and has a contact angle of 70° or less. The epoxy resin included in the second reinforcement layer 22 has a contact angle larger than 70°. The first reinforcement layer 21 in the present embodiment is also referred to as “fiber-reinforced epoxy resin layer”.

Like the reinforcement layer 20 according to the first embodiment, the reinforcement layer 20A according to the present embodiment include a plurality of layers each including carbon fibers. For example, the first reinforcement layer 21 may include 5 layers, while the second reinforcement layer 22 may include 25 layers.

In the high-pressure tank, the innermost layer of the reinforcement layer 20A including a plurality of layers bears stress due to the inner pressure, and thus cracking is likely to occur in the innermost layer (layer formed in contact with the liner 10) of the reinforcement layer 20A first. Cracking formed in the innermost layer will develop toward the outer side. In the high-pressure tank according to the present embodiment, since the epoxy resin included in the first reinforcement layer 21 formed on the liner 10 has a contact angle of 70° or less, occurrence of cracking in the innermost layer of the outer shell can be suppressed. As a result, occurrence of cracking in the outer shell can be suppressed. In addition, selecting different types of resins for the first reinforcement layer 21 and the second reinforcement layer 22 in the reinforcement layer 20A including the carbon fiber-reinforced epoxy resin can achieve the use of types of epoxy resin suited for required performance, for example, to make the first reinforcement layer 21 have a high cracking suppression effect and the second reinforcement layer 22 work well with the protection layer 25.

### A3. Experimental Results

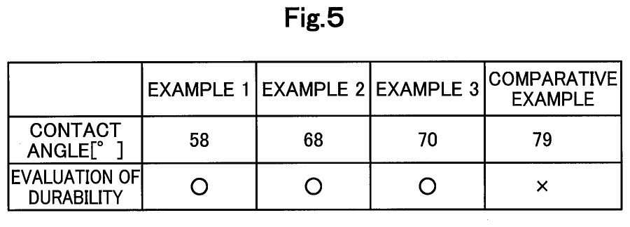

FIG. 5 is a diagram illustrating relationship between the contact angle of the epoxy resin and the durability of the high-pressure tank. High-pressure tanks in Examples 1 to 3 and Comparative Example each have configurations similar to the configuration of the high-pressure tank 100 according to the first embodiment described above. However, more specifically, the high-pressure tanks in Examples 1 to 3 and Comparative Example differ from each other in the contact angle of epoxy resin included in the reinforcement layer 20 and the protection layer 25. The contact angle of epoxy resin is 58° in Example 1, 68° in Example 2, 70° in Example 3, and 79° in Comparative Example. The epoxy resin included in the high-pressure tank in Comparative Example has a main agent that is a bisphenol A type epoxy resin with a molecular weight that differs from that of the main agent of the epoxy resin included in the high-pressure tanks in Examples 1 to 3 and has an olefin-based surfactant. The high-pressure tanks in Examples 1 to 3 and Comparative Example are adjusted such that they have a satisfactory fracture toughness value, tensile elastic modulus, and breaking elongation as a high-pressure tank. More specifically, they are adjusted to achieve a fracture toughness value K1C equal to or more than 1.6 [MPa·m^{1/2}], a tensile elastic modulus equal to or more than 1500 [MPa], and a breaking elongation equal to or more than 4.5[%].

Examples 1 to 3 resulted in good durability, while Comparative Example resulted in poor durability. In FIG. 5, results with good durability are indicated by ◯, and results with poor durability are indicated by X. Evaluation of durability was made such that a room-temperature pressure cycle test was carried out 22,000 times after a pressure test, and no leakage of the fluid from the high-pressure tank led to good durability and leakage observed led to poor durability. From the high-pressure tank in Comparative Example, leakage was observed after the pressure cycle test was carried out 10,100 times and 15,400 times. The following lists details of the pressure test and the room-temperature pressure cycle test.

### <Pressure Test>

Complying with the expansion measurement test (expansion volume not measured) in the KHKS0128(2010) set test, which is a technical standard for containers in 70-MPa compressed hydrogen automobile fuel devices.

Initial pressure: 3 MPa Retention time: 60 (+30/−0) sec

Pressure rise rate: 0.2 MPa/sec or less

Final pressure: 105 MPa Retention time: 30 (+15/−0) sec

### <Room-Temperature Pressure Cycle Test (Hydraulic Pressure)>

Complying with the Global Technical Regulations No. 13 (GTR No. 13), 5.1.1.2. and 6.2.2.2.

Pressure medium: Tap water

Environmental temperature and tank surface temperature: Room temperature+/−5° C.

Cycle: 3 times/min or less (20 sec/time or more)

Pressure: Max 87.5 (+4/−0) MPa, Min 2 (+0/−2) MPa

Number of times the cycle test was repeated: 22,000 cycles

As can be apparent from the experimental results (FIG. 5), if the epoxy resin has a contact angle of 70° or less, occurrence of cracking in the outer shell of the high-pressure tank was able to be suppressed satisfactorily. The epoxy resin with a contact angle of 70° or less has good wettability in an uncured state and thus easily penetrates between tow carbon fibers when the fibers are impregnated with the resin. Therefore, the epoxy resin when cured fills the space between the fibers, whereby formation of voids (minute cavities) in the reinforcement layer 20 is suppressed. As a result, concentration of stress in the reinforcement layer 20 is alleviated, whereby occurrence of cracking in the reinforcement layer 20 because of a change in the volume as a result of the filling and release of hydrogen gas in the high-pressure tank 100 can be suppressed.

### B. Modifications

(1) The fluid in the high-pressure tank 100 is not limited to compressed hydrogen described above, as long as it is a high-pressure fluid such as compressed nitrogen.

(2) Examples of the fibers included in the reinforcement layers 20, 20A and the protection layer 25 may include various types of fibers that can serve as fiber-reinforced resin, such as carbon fibers, glass fibers, aramid fibers, Dyneema fibers, Zylon fibers, and boron fibers. The types of fibers are preferably selected such that the reinforcement layers 20, 20A can withstand high pressure and the protection layer 25 has higher impact resistance than the reinforcement layer 20. Preferably, carbon fibers are used for the reinforcement layers 20, 20A and glass fibers or aramid fibers are used for the protection layer 25, so that the reinforcement layers 20, 20A can withstand high pressure and the protection layer 25 has higher impact resistance than the reinforcement layers 20, 20A.

(3) The protection layer 25 may be formed using only thermoset resin. In other words, the protection layer 25 may include no fibers. In this case, thermoset resin that has higher desired impact resistance than the reinforcement layer 20 is preferably selected for the protection layer 25. To form the protection layer 25 using only thermoset resin, the thermoset resin is sprayed by a known method, such as spray coating, and then heated to form the protection layer 25. For example, to form the protection layer 25 using only thermoset resin, carbon fibers impregnated with epoxy resin are wound around the liner 10, the thermoset resin is sprayed by a known method, such as spray coating, and then heated to cure the epoxy resin and the thermoset resin, whereby the reinforcement layer 20 and the protection layer 25 are formed.

(4) The above-described embodiments illustrate configurations in which the reinforcement layer 20 and the protection layer 25 are disposed on the liner 10, but this is not construed in a limiting sense. The outer side of the liner 10 is provided at least with a fiber-reinforced epoxy resin layer including epoxy resin with a contact angle of 70° or less. That is, in the above-described embodiments, the protection layer 25 may be omitted. Furthermore, an additional layer may be provided at least one of the following: between the liner 10 and the reinforcement layer 20, between the reinforcement layer 20 and the protection layer 25, and to the outer side of the protection layer 25.

(5) The above-described embodiments illustrate examples in which the fiber-reinforced epoxy resin layer including the epoxy resin with a contact angle of 70° or less is formed in contact with the liner 10; however, the fiber-reinforced epoxy resin layer including the epoxy resin with a contact angle of 70° or less is not necessarily formed in contact with the liner 10 as long as it is formed on the outer side of the liner 10. In other words, the innermost layer of the outer shell is not necessarily such a fiber-reinforced epoxy resin layer that includes epoxy resin with a contact angle of 70° or less. For example, a layer including epoxy resin with a contact angle larger than 70° may be formed between the fiber-reinforced epoxy resin layer including the epoxy resin with a contact angle of 70° or less and the liner 10. Also in this configuration, the fiber-reinforced epoxy resin layer including the epoxy resin with a contact angle of 70° or less can suppress occurrence and development of cracking, and thus leakage of the fluid filled in the high-pressure tank can be prevented.

(6) The method for manufacturing the high-pressure tank 100 is not limited to the above-described embodiments. The heating temperature and heating time can be changed as appropriate depending on the type of resin used, the shape of the tank, and the like. The high-pressure tank may also be manufactured by, for example, a sheet winding method in which a sheet of fiber-reinforced resin is bonded, a Resin Transfer Molding (RTM) method in which a sheet of fibers is bonded and then impregnated with resin, and the like.

The technique disclosed herein is not limited to the embodiments or modifications described above but may be implemented by a diversity of other configurations without departing from the scope of the technique. For example, the technical features of any of the above embodiments, examples, and modifications corresponding to the technical features of each of the aspects described in Summary may be replaced or combined as appropriate, in order to solve part or all of the problems described above or in order to achieve part or all of the advantageous effects described above. Any of the technical features may be omitted as appropriate unless the technical feature is described as essential in the description hereof.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) In an aspect of the technique disclosed herein, there is provided a high-pressure tank. The high-pressure tank comprises: a liner; and a fiber-reinforced epoxy resin layer formed on an outer side of the liner. The fiber-reinforced epoxy resin layer may include an epoxy resin and fibers. The epoxy resin has a contact angle on polytetrafluoroethylene ((C₂F₄)ₙ) of 70° or less in an uncured state.

In the high-pressure tank according to the present aspect, since the uncured epoxy resin has a contact angle on polytetrafluoroethylene ((C₂F₄)ₙ) of 70° or less, the uncured epoxy resin has good wettability and easily penetrates between the fibers. Therefore, the epoxy resin when cured fills the space between the fibers, whereby formation of voids (minute cavities) in the fiber-reinforced epoxy resin layer is suppressed. As a result, concentration of stress in the fiber-reinforced epoxy resin layer is alleviated, whereby occurrence of cracking in the fiber-reinforced epoxy layer because of a change in the volume as a result of the filling and release of a fluid in the high-pressure tank can be suppressed.

(2) In the high-pressure tank according to the above-described aspect, the fiber-reinforced epoxy resin layer may be formed in contact with the liner. Among layers formed on the outer side of the liner (hereinafter, also referred to as “outer shell”), cracking is most likely to occur in the layer formed in contact with the liner (innermost layer of the outer shell). In the high-pressure tank according to the present embodiment, the fiber-reinforced epoxy resin layer, in which cracking is less likely to occur, is formed in contact with the liner, whereby occurrence of cracking in the outer shell can be further suppressed.

(3) In the high-pressure tank according to the above-described aspect, the fibers may be carbon fibers, and the high-pressure tank may further comprise a fiber-reinforced resin layer formed on an outer side of the fiber-reinforced epoxy resin layer. The fiber-reinforced resin layer may include; fibers having higher impact resistance than the carbon fibers; and a thermoset resin. This configuration enhances impact resistance and thus can achieve a high-pressure tank with higher strength.

(4) In the high-pressure tank according to the above-described aspect, the fibers having higher impact resistance than the carbon fibers may be glass fibers or aramid fibers. This configuration enables easy manufacturing of a high-pressure tank with higher strength.

The technique disclosed herein may be implemented by any of various aspects. For example, the technique may be implemented in such aspects as a fuel cell system including a high-pressure tank, a moving body equipped with the fuel cell system, a method for manufacturing a high-pressure tank, and the like.

1-4. (canceled)

5. A method of manufacturing a high-pressure tank, comprising:
forming a fiber-reinforced epoxy resin layer on an outer side of a liner, the fiber-reinforced epoxy resin layer including an epoxy resin and fibers, wherein
the epoxy resin includes a silicone-based surfactant, and
during the forming, the epoxy resin has a contact angle on polytetrafluoroethylene ((C₂F₄)ₙ) of 70° or less in an uncured state,
such that the epoxy resin fills spaces between the fibers when the epoxy resin is in a cured state.

6. The method of manufacturing a high-pressure tank according to claim 5,
wherein the fiber-reinforced epoxy resin layer is formed in contact with the liner.

7. The method of manufacturing a high-pressure tank according to claim 5,
wherein the fibers are carbon fibers, and
wherein the method further comprises forming a fiber-reinforced resin layer on an outer side of the fiber-reinforced epoxy resin layer, the fiber-reinforced resin layer including fibers having higher impact resistance than the carbon fibers, and
a thermoset resin.

8. The method of manufacturing a high-pressure tank according to claim 7,
wherein the fibers having higher impact resistance than the carbon fibers are glass fibers or aramid fibers.
